(19) United States
(12) Patent Application Publication
(10) Pub. No.: US 2010/0118280 A1
(43) Pub. Date: May 13, 2010

(54) LIGHT-SOURCE MODULE AND PROJECTOR HAVING SAME

(75) Inventors: CHIEN-FU CHEN, Tu-Cheng (TW); WEI-PING HSU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/346,799

(22) Filed: Dec. 30, 2008

(30) Foreign Application Priority Data
Nov. 10, 2008 (CN) 200810305461.4

(51) Int. Cl. G03B 21/16; F21K 7/00

(52) U.S. Cl. 353/61; 353/52; 362/231

(57) ABSTRACT

A light-source module includes a red light source, a blue light source, a green light source, a first heat sink, and a second heat sink. The first heat sink is attached to the green light source for dissipating heat generated from the green light source. The second heat sink is attached to the red light source and the blue light source for dissipating heat generated from the red light source and the blue light source. The first heat sink is separated from the second heat sink.

### TECHNICAL FIELD

The present disclosure relates to projectors and, particularly, to a light-source module and a projector having the same with effective heat dissipation.

### DESCRIPTION OF THE RELATED ART

Due to reduction of the size of projectors, the density of generated heat in projectors increases quickly. As a result, performance and reliability of the projectors will be influenced if heat dissipation is not effectively provided, and the service life span of the projectors may even be shortened. It is known that the light-source module is a main heat source in a projector, hence, how to discharge the heat generated from the light-source module effectively is a great challenge to designers in related fields.

What is needed, therefore, is a light-source module and a projector having the same with effective heat dissipation.

### BRIEF DESCRIPTION OF THE DRAWINGS

Many aspects of the present light-source module and projector can be better understood with reference to the accompanying drawings. The components in the drawing are not necessarily drawn to scale, the emphasis instead being placed upon clearly illustrating the principles of the present light-source module and projector.

FIG. 1 is a schematic, plan view of a projector according to a first exemplary embodiment.

FIG. 2 is a schematic, plan view of a projector according to a second exemplary embodiment.

### DETAILED DESCRIPTION OF THE EMBODIMENTS

Embodiments of the present disclosure will now be described in detail below, with reference to the accompanying drawings.

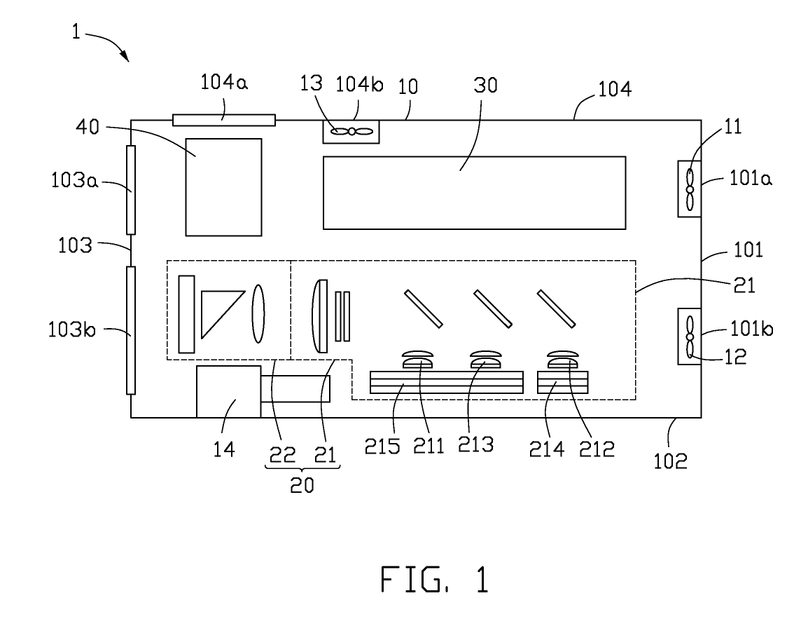

Referring to FIG. 1, a projector 1 according to a first exemplary embodiment is shown. The projector 1 includes a casing 10, an optical engine 20, a driving circuit board 30, and a projection lens module 40.

The casing 10 is configured for housing the optical engine 20, the driving circuit board 30, and the projection lens module 40. The casing 10 includes a front wall 104, a rear wall 102, a first sidewall 101, and a second sidewall 103 opposite to the first sidewall 101. The first sidewall 101, the front wall 104, the second sidewall 103, and the rear wall 102 are connected in sequence. In the present embodiment, the front wall 104 defines an aperture 104a adjacent to the second sidewall 103 and an air inlet 104b located beside the aperture 104a and adjacent the first sidewall 101. The first sidewall 101 defines a first air outlet 101a adjacent the front wall 104, and a second air outlet 101b adjacent the rear wall 102. The second sidewall 103 defines a first air inlet 103a and a second air inlet 103b substantially aligned with the first air outlet 101a and the second air outlet 101b respectively.

In the present embodiment, a first exhaust fan 11 and a second exhaust fan 12 are arranged corresponding to the first air outlet 101a and the second air outlet 101b respectively. A first pulling fan 13 is arranged corresponding to the air inlet 104b for pulling air into the casing 10. A blower 14 is secured on the rear wall 102 for blowing air coming into the casing 10 from the second air inlet 103b towards the second air outlet 101b.

The projection lens module 40 is substantially aligned with the aperture 104a of the front wall 104 and located between the first air outlet 101a and the first air inlet 103a.

The optical engine 20 includes a light-source module 21 and an image forming module 22. The image forming module 22 is configured for producing images towards the projection lens module 40 which focusing the images and then projects the images onto a screen (not shown). The light-source module 21 is configured for providing light for the image forming module 22 to produce the images. The image forming module 22 and the light-source module 21 are arranged between the second air inlet 103b and the second air outlet 101b and are arranged in order from the second air inlet 103b to the second air outlet 101b. The projection lens module 40 is disposed adjacent to the image forming module 22 of the optical engine 20 and with its optical axis substantially perpendicular to the optical engine 20.

The light-source module 21 includes a blue light source 211, a green light source 212, a red light source 213, a first heat sink 214, and a second heat sink 215. The first heat sink 214 is attached to the green light source 212 for dissipating heat generated from the green light source 212. The second heat sink 215 is attached to the blue light source 211 and the red light source 213 for dissipating heat generated from the blue light source 211 and the red light source 213. The first heat sink 214 is separated from the second heat sink 215. In the present embodiment, the blue light source 211, the green light source 212, and the red light source 213 are light emitting diodes (LEDs). The blue light source 211, the green light source 212, and the red light source 213 are arranged on a line substantially perpendicular to the first sidewall 101. The light emitting directions of the blue light source 211, the green light source 212, and the red light source 213 are substantially parallel to each other, and face towards the front wall 104. The air coming into the casing 10 from the second air inlet 103b can be blown towards the second air outlet 101b by the blower 14 passing through the first heat sink 214 and the second heat sink 215. Therefore, the heat generated by the blue light source 211, the green light source 212, and the red light source 213 can be discharged efficiently.

The driving circuit board 30 is electrically connected to the light-source module 21 for driving the light-source module 21. The driving circuit board 30 is disposed between the projection lens module 40 and the first sidewall 101, and substantially aligned with the first air outlet 101a. The air coming into the casing 10 from the first air inlet 103a can pass through the projection lens module 40 and the driving circuit board 30 to dissipate heat from them and then exit the casing 10 from the first air outlet 101a. The air coming into the casing 10 from the air inlet 104a can pass through the driving circuit board 30 to dissipate heat thereof and then exit the casing 10 from the first air outlet 101a.

It is known that, in a projector using LED light source, the power of the green light source 212 is usually much bigger than the power of the blue light source 211 and the power of the red light source 213, therefore, the green light source 212 usually need a more efficient heat dissipating than other light source. In the present embodiment, the green light source 212 is attached to the first heat sink 214 which is separated from the second heat sink 215, thus, the green light source 212 can obtain a more efficient heat dissipating than the blue light source 211 and the red light source 213, accordingly, the light-source module 21 can have a efficient heat dissipating.

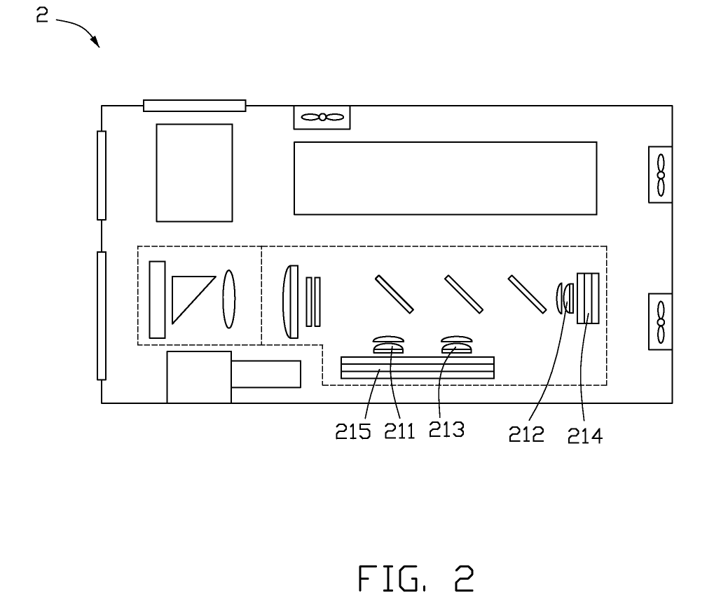

Referring to FIG. 2, a projector 2 according to a second exemplary embodiment is shown. The projector 2 is similar to the projector 1 of the first exemplary embodiment. The difference between the projector 2 and the projector 1 is that, in the projector 2 of the second exemplary embodiment, the blue light source 211, the green light source 212, and the red light source 213 are arranged to form a L-shaped structure. The light emitting direction of the green light source 212 is perpendicular to the light emitting direction of the blue light source 211 and the red light source 213.

While certain embodiments have been described and exemplified above, various other embodiments will be apparent to those skilled in the art from the foregoing disclosure. The present invention is not limited to the particular embodiments described and exemplified, and the embodiments are capable of considerable variation and modification without departure from the scope of the appended claims.

What is claimed is:

1. A light-source module comprising a red light source, a blue light source, a green light source, a first heat sink, and a second heat sink, wherein the first heat sink is attached to the green light source for dissipating heat generated from the green light source, the second heat sink is attached to the red light source and the blue light source for dissipating heat generated from the red light source and the blue light source, the first heat sink is separated from the second heat sink.

2. The light-source module as claimed in claim 1, wherein the red light source, the blue light source, and the green light source are light emitting diodes.

3. The light-source module as claimed in claim 1, wherein the red light source, the blue light source, and the green light source are arranged linearly.

4. The light-source module as claimed in claim 1, wherein the red light source, the blue light source, and the green light source are arranged to form a L-shaped structure.

5. A projector comprising:
a light-source module comprising a red light source, a blue light source, a green light source, a first heat sink, and a second heat sink, the first heat sink being attached to the green light source for dissipating heat generated from the green light source, the second heat sink being attached to the red light source and the blue light source for dissipating heat generated from the red light source and the blue light source, the first heat sink being separated from the second heat sink;
an image forming module for producing images using the light emitted from the light-source module;
a projection lens module for projecting the images produced by the image forming module to a screen;
a driving circuit board capable of driving the light-source module;
a casing for housing the light-source module, the image forming module, the projection lens module, and the driving circuit board.

6. The projector as claimed in claim 5, wherein the red light source, the blue light source, and the green light source are light emitting diodes.

7. The projector as claimed in claim 5, wherein the red light source, the blue light source, and the green light source are arranged linearly.

8. The projector as claimed in claim 5, wherein the red light source, the blue light source, and the green light source are arranged to form a L-shaped structure.

9. The projector as claimed in claim 5, wherein the casing comprises a first sidewall, a front wall, a second sidewall, and the rear wall being connected in sequence, the first sidewall defines a first air outlet and a second air outlet and the second sidewall defines a first air inlet and a second air inlet substantially aligned with the first air outlet and the second air outlet respectively.

10. The projector as claimed in claim 9, wherein the projection lens module and the driving circuit board are arranged between the first air outlet and the first air inlet.

11. The projector as claimed in claim 9, wherein the image forming module and the light-source module are arranged between the second air outlet and the second air outlet.

12. The projector as claimed in claim 9, further comprising a blower for blowing air come into the casing from the second air inlet towards the second air outlet.

13. A projector comprising:
a light-source module comprising a plurality of light sources, a first heat sink, and a second heat sink, the plurality of light sources comprising at least one high-power light source and at least one low-power light source with relative lower power than the high-power light source, the first heat sink being attached to the at least one high-power light source for dissipating heat generated therefrom, the second heat sink being attached to the at least one low-power light source for dissipating heat generated therefrom, the first heat sink being separated from the second heat sink;
an image forming module for producing images using the light emitted from the light-source module;
a projection lens module for projecting the images produced by the image forming module to a screen.

14. The projector as claimed in claim 13, wherein the plurality of light sources comprise a red light source, a blue light source, and a green light source, the red light source and the blue light source are low-power light sources and the green light source is a high-power light source.

15. The projector as claimed in claim 14, wherein the red light source, the blue light source, and the green light source are light emitting diodes.

16. The projector as claimed in claim 14, wherein the red light source, the blue light source, and the green light source are arranged linearly.

17. The projector as claimed in claim 14, wherein the red light source, the blue light source, and the green light source are arranged to form a L-shaped structure.

18. The projector as claimed in claim 13, wherein the casing comprises a first sidewall, a front wall, a second sidewall, and the rear wall being connected in sequence, the first sidewall defines a first air outlet and a second air outlet and the second sidewall defines a first air inlet and a second air inlet substantially aligned with the first air outlet and the second air outlet respectively.

19. The projector as claimed in claim 18, wherein the projection lens module and the driving circuit board are arranged between the first air outlet and the first air inlet.

20. The projector as claimed in claim 18, wherein the image forming module and the light-source module are arranged between the second air outlet and the second air outlet.
